(19) United States
(12) Patent Application Publication
(10) Pub. No.: US 2006/0096929 A1
(43) Pub. Date: May 11, 2006

(54) COLLAPSIBLE STRAINER

(76) Inventors: Timothy Repp, Pleasant Valley, CT (US); Thomas Murphy, Arlington, TX (US)

Correspondence Address: DANIEL V. THOMPSON, 9330 LBJ FWY., SUITE 1185, DALLAS, TX, 75243, US

(21) Appl. No.: 11/163,535

(22) Filed: Oct. 21, 2005

Related U.S. Application Data
(60) Provisional application No. 60/620,296, filed on Oct. 21, 2004.

(51) Int. Cl. C02F 1/00

(52) U.S. Cl. 210/740

(57) ABSTRACT

A strainer has a flexile, elastomeric, perforated membrane.

### CROSS-REFERENCE TO RELATED APPLICATION

This is a non-provisional application based on U.S. Provisional Patent Application Ser. No. 60/620,296 filed Oct. 21, 2004.

### BACKGROUND OF THE INVENTION

The present invention relates to strainers, and more particularly to a strainer that employs a flexile, perforated membrane allowing it to axially collapse to a minimum size when not in use.

### SUMMARY OF THE INVENTION

Perforated strainers, also known in the food preparation art as colanders, are a conventional tool typically formed of a rigid, non-flexile material. A drawback of all rigid strainers and colanders is that their form requires a lot of storage space. The present invention provides a solution to that problem in the form of a strainer that employs a flexile, perforated membrane allowing it to axially collapse to a minimum size when not in use.

This space-saving feature becomes very useful, for example, in kitchens with minimal storage area, but more importantly, inside dishwashers where space is limited. Strainers in the prior art are notoriously difficult to clean by hand because of their perforations and cumbersome size. Size alone is a deterrent for placing them into a dishwasher, which leaves cleaning by hand as the best current option. This invention performs the duties of a full-sized colander but with the added benefit of axially-collapsing to a smaller, more efficient size for storage and dishwasher cleaning.

In the embodiment of the invention shown herein, a rigid support frame with integral handle supports the flexile, perforated membrane that is shaped to facilitate the novel function of the invention. In another embodiment of the invention (not shown herein), the membrane is supported by a rigid support frame that has two sets of pivoting legs to provide a self-supporting strainer. The two pivoting leg assemblies are attached near hand grips at the perimeter of the membrane and may be manually rotated inward so that they become parallel to the support frame. This allows a full sized colander to fit into an unusually small storage space. Other equivalent methods of supporting the membrane are possible, and it is not intended to limit this invention to any particular means of membrane support.

### BRIEF DESCRIPTION OF THE DRAWINGS

A more complete understanding of the invention and its advantages will be apparent from a review of the Detailed Description in conjunction with the following Drawings, in which:

FIG. 1 is a perspective view of a strainer which includes the present invention.

FIG. 2 is a side view of the strainer of FIG. 1 in its storage configuration.

FIG. 3 is a top view of the strainer.

FIG. 4 is a sectional view taken along lines 4-4 of FIG. 3.

FIG. 5 is a side view of the strainer in its use configuration.

FIG. 6 is a partial bottom view of the strainer.

FIG. 7 is a partially broken-away, expanded side view of the stiffening ring and hinge portion of the membrane.

FIG. 8 is a partially broken-away, expanded side view of the perimeter of the membrane and support frame.

### DETAILED DESCRIPTION

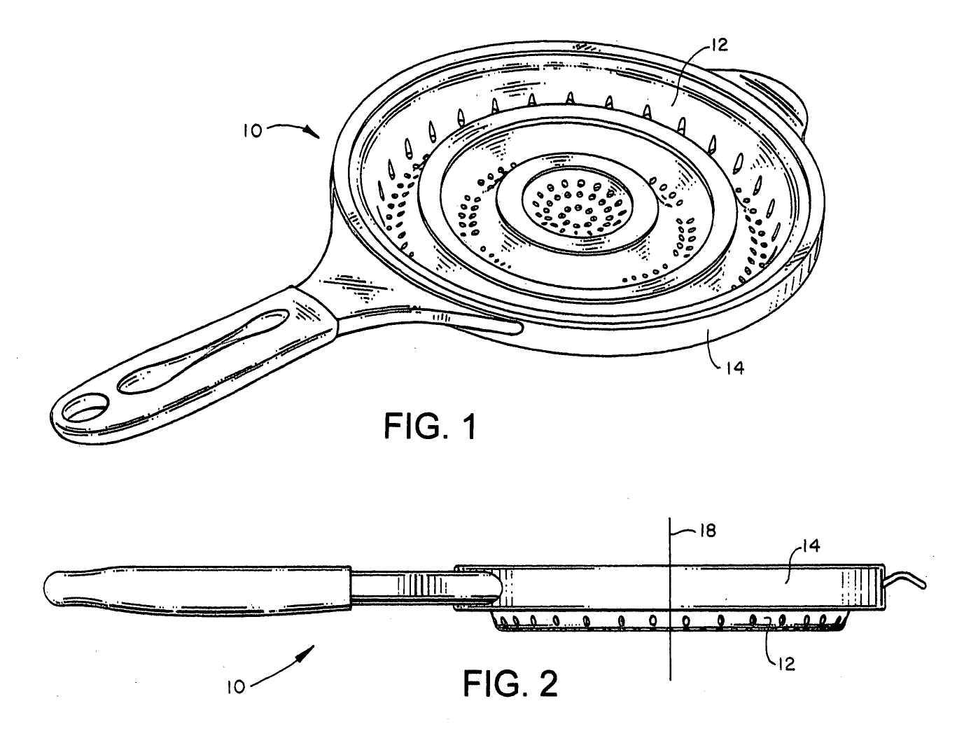

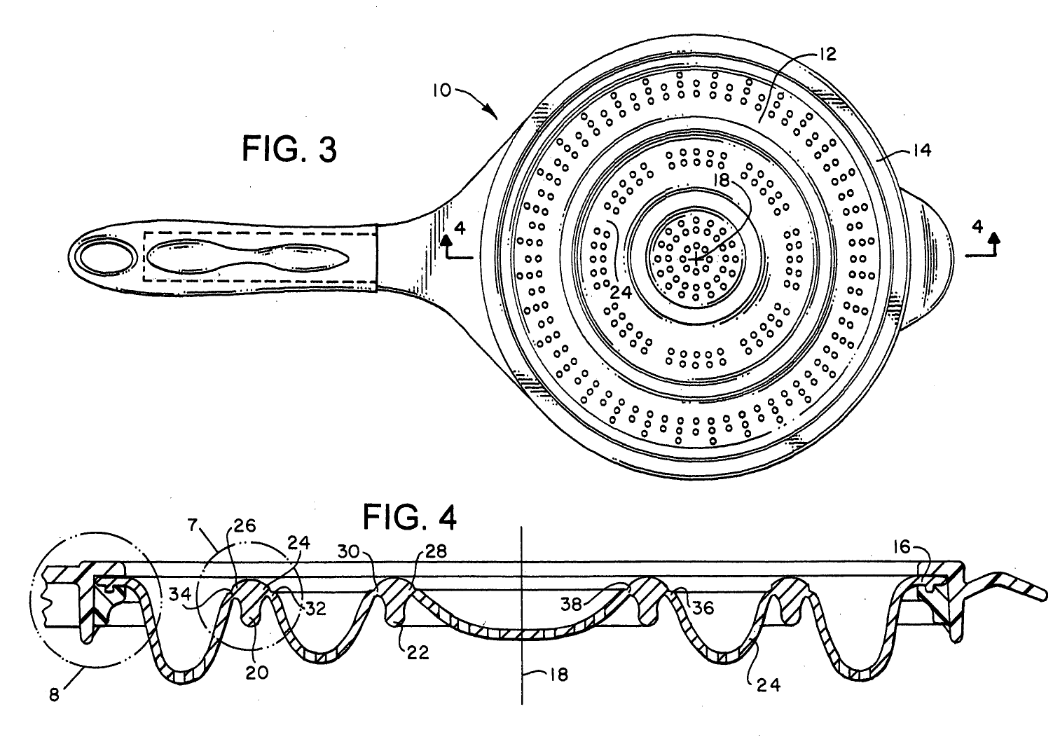

Referring initially to FIGS. 1-8, where like numerals indicate like and corresponding elements, strainer 10 includes a flexile, elastomeric, perforated membrane 12 supported by a rigid support frame 14 about a perimeter 16 (FIGS. 4 and 8) of the membrane 12. “Flexile” is used in its ordinary sense to mean easily bendable.

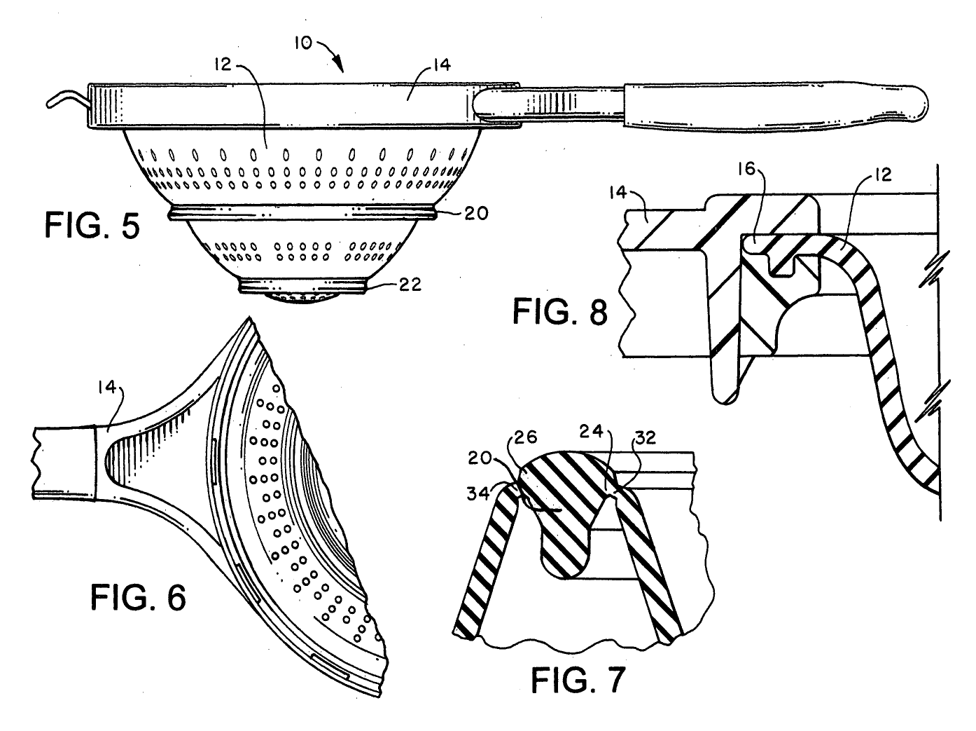

The membrane 12 has at least two selectable configurations, as shown in FIGS. 2 and 5. The two selectable configurations are a near-flat storage configuration (FIG. 2) and an extended use configuration (FIG. 5). In the storage configuration, membrane 12 is approximately the same width as frame 14. In the use configuration, membrane 12 is extended from frame 14 to form an open-topped container or bowl.

A key feature of the invention is that membrane 12 is formed to be stable in both the storage and use configurations. This enables the user to select either configuration, which the membrane 12 will then statically hold indefinitely until it is shifted to the other configuration. One way to provide this feature is to form the membrane 12 to have circular cross-sections about a central axis 18 (FIGS. 2, 3 and 4). The membrane 12 includes at least one, and in this embodiment, two stiffening rings 20,22 formed in a wavy, medial portion 24 of the membrane 12. Stiffening ring 20 has inner side 24 and outer side 28. Stiffening ring 22 has inner side 26 and outer side 30. At least four hinges 32,34,36,38 are provided, one hinge on each of the inner and outer sides of each stiffening ring as shown in FIGS. 4 and 7. The hinges 32,34,36,38 are reduced in thickness compared to the perforated portions of membrane 12, such that they are even more flexile and deformable than the rest of the membrane. Stiffening rings 20,22 in contrast are relatively thick, so they are less flexile than the rest of the membrane and more strongly resist deformation. Stiffening rings 20,22 prevent the portions of membrane 12 adjacent to them from being in any state other than the storage and use configurations.

One example of the membrane 12 is formed of silicone rubber with a softness on the Shore A scale of about 25. The perforated portions of the membrane are about 2 mm thick, while the hinges are about 0.85 mm thick. The membrane has a diameter of about 20 cm.

In operation, in its storage configuration, the flexile, perforated membrane is in a near-flat shape, suspended at its perimeter by a support frame which, in this embodiment, includes a single radially-extending handle. For use, the strainer is taken from its storage space and brought to a sink. The user grips the handle and positions the membrane over the sink. Foods that require cleansing or draining are placed onto the flexile, perforated membrane. The flexile, perforated membrane will expand downward to its use configuration to accommodate the food, or the membrane can be manually depressed for lighter items. It is also possible to “pop” the membrane out to its use configuration by swinging the frame ping-pong paddle style with a sudden stop. The user then rinses the food with water which exits through the perforations into the sink. Lastly, the user lifts the strainer and empties its contents in a manner consistent with the prior art. The flexile, perforated membrane is manually returned to its original near-flat form, and the strainer can again be brought to it's storage configuration for washing and storage.

The stiffening ring/hinge combination enables a wavy “ripple” cross section of the membrane. This wavy cross-section, with rounded folds, should be contrasted with “accordion” or sharp-edged folds. This cross-section allows for two advantages: easier moldability of the holes and better exposure of the surfaces of the collapsed strainer to the cleansing jets in a dishwasher. Accordion-like folds would not accommodate the addition of drainage holes without sacrificing durability and quality. In addition, these accordion-like features collapse tightly together when compacted which would not adequately expose the surfaces of the strainer to the benefits of a dishwasher's high temperature cleansing jets.

The unique “ripple and ring” feature developed for our collapsible strainer basket solves these problems. The design allows for multiple drainage holes to be placed from top to bottom of the expanded basket. When flattened, the surfaces and holes remain exposed in a dishwasher for optimum cleansing. The stiffening rings added to the bottom of each ripple allow the basket to flex open and closed while retaining a uniform shape.

While the invention has been illustrated and described as embodied one type of strainer, it is not intended to be limited to the details shown, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is:

1. A strainer, comprising a flexile, perforated membrane.

2. The strainer of claim 1 where the membrane is integrally formed of an elastomeric material and has at least two selectable configurations.

3. The strainer of claim 2 where the two selectable configurations are a near-flat storage configuration and an extended use configuration.

4. The strainer of claim 3 where the membrane has circular cross-sections about a central axis.

5. The strainer of claim 1 with the membrane supported by a rigid support frame about a perimeter of the membrane.

6. The strainer of claim 5 with a radially-extending handle connected to the support frame.

7. A strainer, comprising:
a flexile, integrally elastomeric, perforated membrane;
where the membrane has at least two selectable configurations;
where the two selectable configurations are a near-flat storage configuration and an extended use configuration;
where the membrane has circular cross-sections about a central axis; and
with the membrane supported by a rigid support frame about a perimeter of the membrane.

8. The strainer of claim 7 with a radially-extending handle connected to the support frame.

9. The strainer of claim 4 with the membrane including at least one stiffening ring formed in a wavy, medial portion of the membrane.

10. The strainer of claim 9 with at least one hinge formed in the membrane adjacent the stiffening ring.

11. The strainer of claim 9 with the stiffening ring having inner and outer sides, and with at least two hinges, one hinge on each of the inner and outer sides of the stiffening ring.

12. The strainer of claim 4 with the membrane including at least two stiffening rings formed in a medial portion of the membrane.

13. The strainer of claim 12 with at least one hinge formed in the membrane adjacent each of the stiffening rings.

14. The strainer of claim 12 with each stiffening ring having inner and outer sides, and with at least four hinges, one hinge on each of the inner and outer sides of each stiffening ring.

15. A strainer, comprising:
a flexile, integrally elastomeric, perforated membrane;
where the membrane has at least two selectable configurations;
where the two selectable configurations are a near-flat storage configuration and an extended use configuration;
where the membrane has circular cross-sections about a central axis;
with the membrane supported by a rigid support frame about a perimeter of the membrane;
with the membrane including at least one stiffening ring formed in a wavy, medial portion of the membrane; and
with at least one hinge formed in the membrane adjacent the stiffening ring.

16. The strainer of claim 15 with a radially-extending handle connected to the support frame.

17. The strainer of claim 15 with the stiffening ring having inner and outer sides, and with at least two hinges, one hinge on each of the inner and outer sides of the stiffening ring.

18. The strainer of claim 15 with the membrane including at least two stiffening rings formed in a medial portion of the membrane.

19. The strainer of claim 18 with at least one hinge formed in the membrane adjacent each of the stiffening rings.

20. A strainer, comprising:
a flexile, elastomeric, perforated membrane;
where the membrane has at least two selectable configurations;
where the two selectable configurations are a near-flat storage configuration and an extended use configuration;
where the membrane has circular cross-sections about a central axis;
with the membrane supported by a rigid support frame about a perimeter of the membrane;
with the membrane including at least two stiffening rings formed in a medial portion of the membrane; and
with each stiffening ring having inner and outer sides, and with at least four hinges, one hinge on each of the inner and outer sides of each stiffening ring.
